(19) United States
(12) Patent Application Publication
(10) Pub. No.: US 2025/0082972 A1
(43) Pub. Date: Mar. 13, 2025

(54) METHOD AND DEVICE FOR DETECTING FOREST FIRES

(71) Applicant: DRYAD NETWORKS GMBH, Eberswalde (DE)

(72) Inventors: Carsten BRINKSCHULTE, Berlin (DE); Daniel HOLLOS, Berlin (DE)

(73) Assignee: DRYAD NETWORKS GMBH, Eberswalde (DE)

(21) Appl. No.: 18/580,188

(22) PCT Filed: Jul. 13, 2022
(86) PCT No.: PCT/EP2022/069650

§ 371 Date: Jan. 18, 2024

(30) Foreign Application Priority Data
Jul. 19, 2021 (DE) 10 2021 118 527.0
Nov. 4, 2021 (DE) 10 2021 128 720.0

(51) Int. Cl. A62C 3/02; H04W 4/38

(52) U.S. Cl. CPC A62C 3/0271; H04W 4/38

(57) ABSTRACT

The invention relates to a method for forest fire early detection having the steps of implementing machine learning data (ML data) for the detection of forest fires in a forest fire early detection system, recording measurement data by a terminal device of the forest fire early detection system and determining result data by applying the ML data to the measurement data recorded by the terminal device, with the ML data being implemented in the terminal device, as well as a forest fire early detection system with a LoRaWAN network.

The invention relates to a method for forest fire early detection having the method steps of implementing machine learning data (ML data) for the detection of forest fires in a forest fire early detection system, recording measurement data by a terminal device of the forest fire early detection system and determining result data by applying the ML data to the measurement data measured by the terminal device, with the ML data being implemented in the terminal device, as well as a forest fire early detection system with a LoRaWAN network.

### PRIOR ART

The larger a forest fire is, the more difficult it is to determine its direction and speed of spread. Weather, wind, soil conditions and vegetation determine its path and speed of spread, which can change again within a short period of time. It is therefore very important to detect a forest fire very early in order to keep the damage to a minimum and keep the forest fire controllable or to give the fire brigade a decisive time advantage.

During a forest fire, the complex thermal degradation processes (distillation, pyrolysis, charring and the oxidation of the resulting gas products during flame combustion) occur simultaneously and often in close proximity to one another. Thermal degradation of fuels occurs in front of and along the fire line, while enclaves of intermittent open flame often persist well behind the flame front.

Flame combustion is generally between 800° C.-1200° C. Smoldering ground fires range between 300° C.-600° C. Combustible gases, especially volatile organic compounds (VOCs for short), are formed more quickly at temperatures above 200° C. and reach their peak at 320° C. VOC is the collective name for organic, carbon-containing substances that evaporate into the gas phase at room temperature or higher temperatures, especially terpenes. In addition, various organic compounds are formed, such as methanol, and carbon dioxide, as well as carbon monoxide and molecular hydrogen. Flaming combustion only begins at 425° C. to 480° C. Flame temperatures of 700° C. to 1300° C. are the most common. In this temperature range, carbon dioxide, nitrogen oxides and volatile sulfur-containing compounds (VSC), especially sulfur dioxide, are formed. Smoldering fires spread slowly, approximately 3 cm/h, and can produce ground temperatures of over 300° C. for several hours, with peak temperatures of 600° C.

The following table shows the gases formed in a forest fire, graded according to temperature:

| | | Low- | | Smoldering/ | | | |
|---|---|---|---|---|---|---|---|
| Fire | Distillation/ | temperature | Carbon | glowing | Flaming | | |
| phase | drying | pyrolysis | oxidation | combustion | combustion | Indices | BME688 |
| Temperature | 60° C.-200° C. | 200° C.-300° C. | 320° C. | 300° C.-600° C. | 800° C.-1200° C. | | |
| Time | 1-30 min | 1-60 min | | | | | |
| Gases | VOC | CO | Furan | | CO2 | CE | 1,3- |
| | | | | | | | Butadiene |
| | Terpenes | CO2 | | | NOx | MCE | H2 |
| | Methanol | Nitrogen- | | | Sulfur dioxide | | VOC |
| | | enriched VOC | | | (SO2) | | |
| | Acetaldehyde | Methanol | | | Aerosol | | CO |
| | Acetic acid | Acetic acid | | | | | CO2 |
| | Methyl acetate | Acetone | | | | | Acetone |
| | | 1,3-Butadiene | | | | | |
| | | Furan | | | | | |
| | | 2-Furaldehyde | | | | | |
| | | H2 | | | | | |

Earth observation data, particularly in the form of aerial and satellite images, can provide possible help in detecting a forest fire. The sharp increase in available earth observation data, particularly from aerial and satellite image data, enables forest fires to be detected over a wide area. As useful as satellite data are for detecting and fighting fires, they have one disadvantage: they usually only reach the emergency services with a delay because geostationary satellites only provide low image resolution due to their great distance and non-geostationary satellites have to complete an orbit around the earth before they can they can provide new recordings.

Another option for detecting forest fires is to install a network of gas sensors directly in the forest, which detect gases that occur when forest fires develop and thus be able to detect forest fires at a very early stage, before they can be detected from a distance by optical systems. Due to the different vegetation in forests and the different properties of soils, different gases and gas concentrations also arise, making error-free detection very difficult. In addition, different gases and gas concentrations are created simply due to the increasing temperatures in the different phases of forest fire development. However, since deploying emergency services is very expensive, the detection accuracy should be improved.

It is therefore the aim of the present invention to provide a method for forest fire early detection that works reliably, can be expanded as required and is inexpensive to install and maintain, and enables the direction and speed of spread of a forest fire to be recorded and predicted. It is also the aim of the present invention to provide a system for forest fire early detection that works reliably, can be expanded as required and is inexpensive to install and maintain, and enables the direction and speed of spread of a forest fire to be recorded and predicted.

The aim is achieved using the method for forest fire early detection according to claim 1. Advantageous embodiments of the invention are set out in dependent claims 2 to 14.

The method according to the invention for forest fire early detection has three method steps: In the first method step, ML data for the detection of forest fires is implemented in a forest fire early detection system. In the context of this document, ML data is data that is created using the algorithm of a machine learning model. In the second method step, measurement data is recorded by a terminal device in the forest fire early detection system. For this purpose, the terminal device has one or more suitable sensor devices for gas analysis, for example, and/or is connected to such sensor devices. In the third method step, result data is determined by applying the ML data to the measurement data recorded by the terminal device. The machine learning model is used in this invention to improve the efficiency of the sensor device of the terminal device. The model's algorithm enables improved application-related detection of the gases to be detected. The algorithm also corrects the recorded gas concentration in relation to the recorded air humidity. In addition, the baseline and long-term deviations of the measured values are compensated. For this purpose, the terminal device is provided with data about different gas compositions and their concentrations, which is compared with the gas compositions and their concentrations determined by the sensor device.

The measured values recorded and transmitted by the terminal device are integrated into a machine learning model to create models for detecting forest fires. Forest fire detection data is made available via APIs and graphical tools. With such models, a fire can be detected even in remote areas. By evaluating this data, statements can be made about the current situation after forest fires.

According to the invention, the ML data is implemented in the terminal device instead of in a central unit, for example a network server. A forest fire early detection system usually has a large number of terminal devices that are distributed over a wide area and have self-sufficient energy supply systems. The implementation of the ML data in the terminal device enables the machine learning model to be adapted and applied to the local conditions of the respective terminal device. At the same time, the energy consumption of an individual terminal device is reduced because only a reduced amount of data has to be transmitted.

In a further embodiment of the invention, the result data is determined on the terminal device. The terminal device has an evaluation device for this purpose. The result data is determined by applying ML data to the measurement data recorded by the terminal device.

In a further embodiment of the invention, the result data is transmitted to the network server. On the network server, the result data is available to other applications that detect and record a forest fire. By integrating the measurement data into a machine learning model, models for detecting forest fires are also created using the network server. The result data can include the result of the comparison of the measurement data with the ML data, even just an evaluation of the comparison of the measurement data with the ML data and/or a simple warning signal. In any case, the result data shows whether a forest fire was detected by the sensor of the terminal device.

In a further development of the invention, only part of the result data and/or an evaluation of the result data is transmitted to the network server.

In an advantageous embodiment of the invention, the transmission takes place using protocols such as LoRa, LoRaWAN and/or IP. LoRa uses particularly low energy and is based on chirp frequency spread modulation according to U.S. Pat. No. 7,791,415 B2. Licenses for use are granted by a founding member of the industrial consortium, the company Semtech. LoRa uses license- and permit-free radio frequencies in the range below 1 GHz, such as 433 MHz and 868 MHz in Europe or 915 MHz in Australia and North America, allowing a range of more than 10 kilometers in rural areas with the lowest energy consumption. The LoRa technology consists of the physical LoRa protocol and the LoRaWAN protocol, which is defined and managed as the upper network layer by the industrial consortium LoRa Alliance. LoRaWAN networks implement a star-shaped architecture using gateway message packets between the terminal devices and the central network server. The gateways (also called concentrators or base stations) are connected to the network server via the standard Internet protocol, while the terminal devices communicate with the respective gateway via radio via LoRa (chirp frequency spread modulation) or FSK (frequency modulation). The radio connection is therefore a single-hop network in which the terminal devices communicate directly with one or more gateways, which then forward the data traffic to the Internet. Conversely, data traffic from the network server to a terminal device is only routed via a gateway. Data communication basically works in both directions, but data traffic from the terminal device to the network server is the typical application and the predominant operating mode. By bridging larger distances with very low energy consumption, LoRaWAN is particularly suitable for IoT applications outside of settlements.

On the physical level, LoRaWAN, like other wireless protocols for IoT applications, uses spread spectrum modulation. It differs by using an adaptive technique based on chirp signals, as opposed to traditional DSSS (Direct Sequence Scatter Spectrum Signaling). The chirp signals offer a compromise between reception sensitivity and maximum data rate. A chirp signal is a signal that varies in frequency over time. LoRaWAN technology can be implemented cost-effectively because it does not rely on a precise clock source. LoRa's range extends up to 40 kilometers in rural areas. In the city, the advantage is good building penetration, as cellars can also be reached. The current requirement is very low at around 10 nA and 100 nA in sleep mode. This means a battery lifespan of up to 15 years can be achieved.

LoRaWAN defines and uses a star topology network architecture in which all the leaf nodes communicate via the most suitable gateway. These gateways handle routing and, if more than one gateway is within range of a leaf node and the local network is congested, they can also redirect communication to an alternative.

However, some other IoT protocols (e.g. ZigBee or Z-Wave) use so-called mesh network architectures to increase the maximum distance of a terminal device leaf node from a gateway. The terminal devices in the mesh network forward the messages to each other until they reach a gateway, which transfers the messages to the Internet. Mesh networks program themselves and dynamically adapt to environmental conditions without the need for a master controller or hierarchy. However, in order to be able to forward messages, the terminal devices of a mesh network must be ready to receive either constantly or at regular intervals and cannot be put into sleep mode for long periods of time. The result is a higher energy requirement for the node terminal devices to forward messages to and from the gateways and a resulting shortening of battery life.

The star network architecture of LoRaWAN, on the other hand, allows the terminal devices to enter the energy-saving idle state for long periods of time, thereby ensuring that the battery of the terminal devices is put under as little strain as possible and can therefore be operated for several years without changing the battery. The gateway acts as a bridge between simple protocols optimized for battery life (LoRa/LoRaWAN), which are better suited for resource-limited terminal devices, and the Internet Protocol (IP), which is used to provide IoT services and applications. After the gateway has received the data packets from the terminal device via LoRa/LoRaWAN, it sends them via the Internet Protocol (IP) to a network server, which in turn has interfaces to IoT platforms and applications. In a further embodiment of the invention, the result data is collected on the terminal device. The result data is collected in the memory of the terminal device until it is transmitted to the network server as a data packet via one or more gateways within a download-receive window. The terminal device does not have to have a permanently active download-receive window and therefore be permanently active, as with a class C terminal device, but can also be, for example, a class A or class B terminal device in accordance with the LoRaWAN specification. The energy requirement of a terminal device is thus minimized. In a further embodiment of the invention, the result data is transmitted to the network server at specified intervals. The terminal devices are divided into three different bidirectional variants: Class A includes communication using the ALOHA access method. With this procedure, the device sends its generated data packets to the gateway, followed by two download-receive windows that can be used to receive data. A new data transfer can only be initiated by the terminal device during a new upload. Class B terminal devices, on the other hand, open download-receive windows at specified times. To do this, the terminal device receives a time-controlled beacon signal from the gateway. This means that a network server knows when the terminal device is ready to receive data. Class C terminal devices have a permanently open download-receive window and are therefore permanently active, but also have increased power consumption. In order to minimize the energy requirements of the terminal devices, only class A and B terminal devices are usually used to carry out the method according to the invention.

In a further development of the invention, the intervals are set based on time or data volume. Class B terminal devices transmit the result data at specified times. Class A terminal devices can also send the result data to the network server at specified times. However, they can also have the option of transmitting the result data if the result data has a fixed data volume. This prevents the data volume from being too large for the memory of the terminal device.

In a further embodiment of the invention, the terminal device has a communication unit. The result data is transmitted from the terminal device to the network server using the communication unit. The communication unit is deactivated after the result data has been transmitted in order to reduce the energy requirements of the terminal device.

In an advantageous embodiment of the invention, an ML algorithm is applied to the result data. The ML algorithm enables improved application-related detection of the gases to be detected. The algorithm also corrects the recorded gas concentration in relation to the recorded air humidity. In addition, the baseline and long-term deviations of the measured values are compensated. For this purpose, the terminal device is provided with data about different gas compositions and their concentrations, which is compared with the gas compositions and their concentrations determined by the sensor device.

In a further embodiment of the invention, the first application of the ML algorithm takes place before the software is installed on the terminal device and/or before the sensor device is installed within a forest fire monitoring system. Reinforcement learning is preferred for this. The algorithm learns tactics through reward and punishment on how to act in potentially occurring situations to maximize the benefit of the forest fire monitoring system.

In an advantageous embodiment of the invention, the application of the ML algorithm takes place after the software is installed on the terminal device and/or after the sensor device is installed within a forest fire monitoring system. This has the advantage that the adaptation and application of the machine learning model can be adapted to the on-site conditions. In a further development according to the invention, the adaptation and application of the machine learning model is carried out via a wireless network. In particular, the adaptation and application of the machine learning model of the terminal device is updated via the control unit, preferably at regular intervals.

In a further development of the invention, the newly determined ML data is transmitted to the terminal devices via a wireless network. Advantageously, the newly determined ML data is transmitted to the terminal device using the same network architecture by which the terminal device sends result data to a network server. The transmission takes place using protocols such as LoRa, LoRaWAN and/or IP. The network server sends the newly determined ML data to a gateway using IP, and the gateway sends it to a terminal device via LoRa/LoRaWAN.

In a further embodiment of the invention, reinforcement learning is used. The algorithm learns a tactic through reward and punishment on how to act in potentially occurring situations in order to maximize the utility of the agent (i.e. the system to which the learning component belongs). The algorithm learns a function from given pairs of inputs and outputs. During the learning process, a “teacher” provides the correct function value for an input. The purpose of the supervised learning is to train the network to create associations after several calculations with different inputs and outputs.

The aim is also achieved using a forest fire early detection system with a LoRaWAN network according to claim 15. Advantageous embodiments of the invention are set out in the dependent claims.

The forest fire early detection system according to the invention with a LoRaWAN network has a terminal device. The terminal device comprises has a sensor device which has one sensor or a plurality of sensors, for example for gas analysis. The forest fire early detection system according to the invention also has a first control device, an evaluation device for evaluating the measurement signals supplied by the sensor device and a device for supplying energy. The energy supply device enables the terminal device to be operated autonomously, for example by allowing a battery to be charged via, for example, solar cells. The forest fire early detection system according to the invention also has a network server. The network server has interfaces to other applications with which, for example, the direction and speed of spread of a forest fire can be determined. According to the invention, the first control device is suitable and intended to access a memory that contains data from the adaptation and application of a machine learning model. The model's algorithm enables improved application-related detection of the gases to be detected. The algorithm also corrects the recorded gas concentration in relation to the recorded air humidity. In addition, the baseline and long-term deviations of the measured values are compensated. For this purpose, the sensor system is provided with data about different gas compositions and their concentrations, which is compared with the gas compositions and their concentrations determined by the sensor.

In a further development of the invention, the memory is part of the terminal device. The terminal device has a housing to protect the components from the effects of the weather. The memory is also arranged in the housing and connected to the first control device. In a further embodiment of the invention, the network server is coupled to a second control device which is suitable and intended to execute a machine learning program. The second control device has a system that has a machine learning algorithm. The machine learning algorithm uses training data to improve the machine learning model.

In a further embodiment of the invention, the second control device has access to the measurement signals recorded by the terminal device. The measurement signals recorded by the terminal device are training data with which a machine learning algorithm of the second control device is trained.

In a further embodiment of the invention, the second control device is connected to the terminal device via two different networks.

In a further embodiment of the invention, the terminal device has a humidity sensor for detecting the air humidity. Air humidity, especially relative humidity, is an indicator of the risk of forest fires.

In a further development of the invention, the terminal device has a temperature sensor for detecting the ambient temperature. An obvious indicator of the presence of a forest fire is the temperature of the air.

In a further embodiment of the invention, the terminal device has a pressure sensor for detecting the air pressure. By recording the air pressure, predictions of the wind direction and wind speed and thus also the speed and direction of spread can be made.

Exemplary embodiments of the method according to the invention for forest fire early detection and of the forest fire early detection system according to the invention are shown schematically in simplified form in the drawings and explained in more detail in the following description.

Wherein:

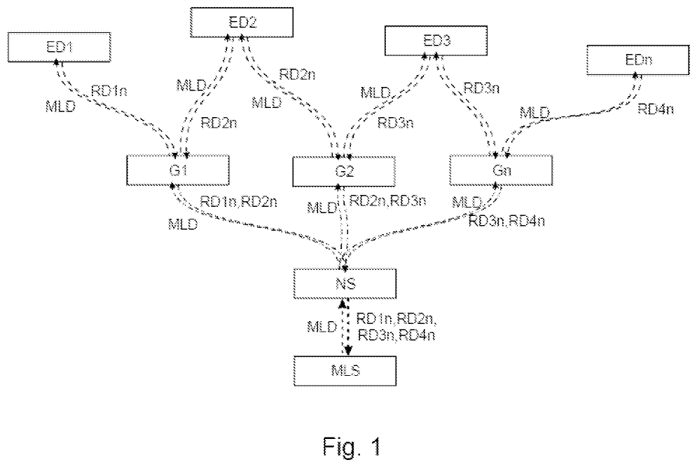

FIG. 1: Structure of a forest fire early detection system having a LoRa wireless network with sending of result data and ML data

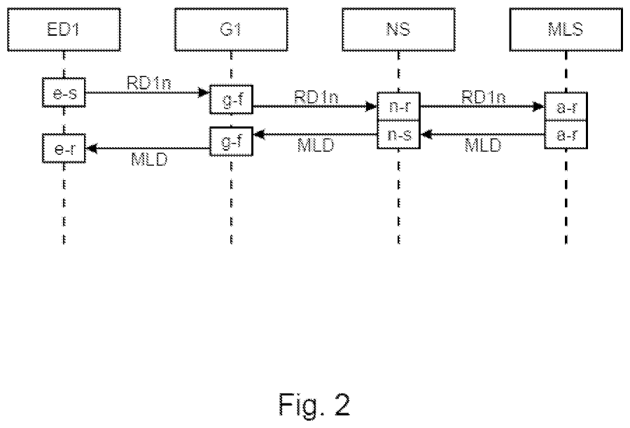

FIG. 2: Sequence diagram of the forest fire early detection system using the LoRa wireless network

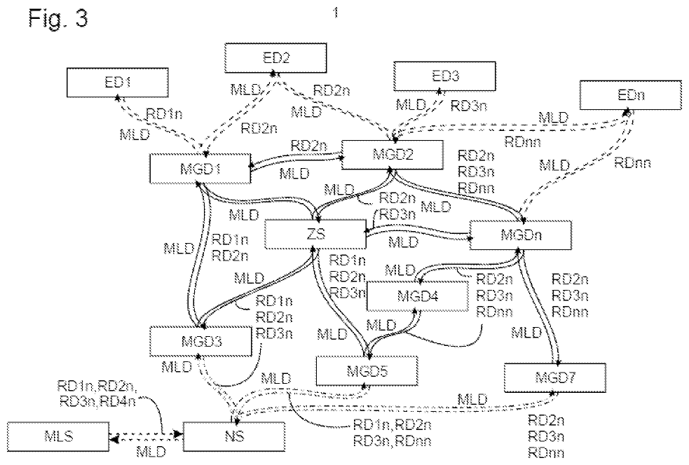

FIG. 3: Forest fire early detection system comprising a LoRaWAN mesh gateway network with terminal devices, a network server and mesh gateways

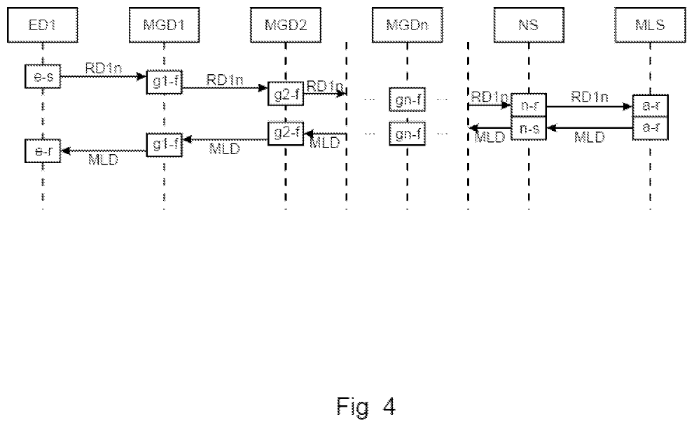

FIG. 4: Sequence diagram of the forest fire early detection system using a LoRaWAN mesh gateway network with terminal devices, a network server and mesh gateways

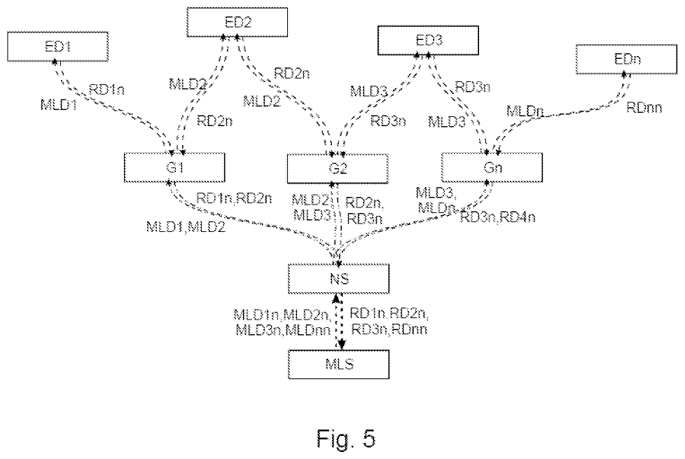

FIG. 5: Structure of a forest fire early detection system comprising a LoRaWAN mesh gateway network, repeated sending of result data and ML data

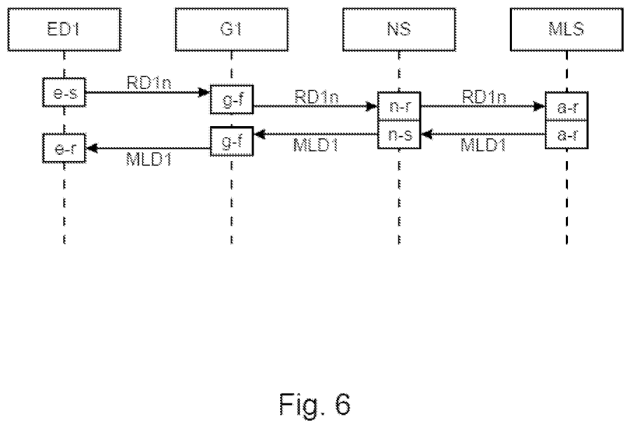

FIG. 6: Sequence diagram of the forest fire early detection system using the LoRaWAN mesh gateway network, repeated sending of result data and ML data

FIG. 1 shows a forest fire early detection system 1 according to the invention. The forest fire early detection system 1 has a plurality of terminal devices ED. To detect a forest fire, a single terminal device ED has a sensor unit that has sensors for determining the air humidity, the air pressure, and a temperature sensor. Optionally or additionally, a terminal device ED has sensors for gas analysis and for detecting the prevailing wind direction, with which the composition and concentration of gases as well as their direction of spread are determined.

In order to be able to install and operate the terminal device ED even in inhospitable and especially rural areas far from energy supplies, a terminal device ED is equipped with a self-sufficient energy supply. In the simplest case, the energy supply is a battery, which can also be designed to be rechargeable. It is also possible to use capacitors, such as supercapacitors. The use of solar cells is somewhat more complex and cost-intensive, but offers a very long service life for the terminal device ED.

The terminal device ED also has a communication interface as well as a first control device and an evaluation device. The communication interface of the terminal device ED is connected wirelessly to communication interfaces of the gateways Gn. The first control device is connected to the communication interface and the sensor device and controls them.

In order to carry out the method for forest fire early detection according to the invention, the position of each individual terminal device ED must be known as precisely as possible. The position can be determined, for example, when installing the terminal device ED. The terminal device ED can, for example, be arranged on a tree in the forest to be monitored and the position of the terminal device ED can be determined using a navigation system, for example a satellite navigation system, for example GPS (Global Positioning System). To detect a forest fire, measurement data is recorded by the sensor device of the terminal device ED of the forest fire early detection system 1. The measurement data is not recorded continuously, but at adjustable intervals; recording every 5 minutes is preferred. This reduces the power consumption of the terminal device ED. The control unit of the terminal device ED collects the measured values of the sensor device and stores them in the memory. The first control device of the terminal device ED generates result data RDnn by applying ML data to the recorded measurement data. In this and all following exemplary embodiments, the memory of a terminal device EDn has an ML data set that was stored in the memory before the software of the sensor device was installed and/or in particular before the terminal devices EDn were installed within a forest fire monitoring system 1. The ML data set MLD is generated externally. For this purpose, for example, forest components, such as the fauna found in forests, forest floor components and/or loose material located on the forest floor, are heated and/or burned at different temperatures in a laboratory and the resulting gases are detected. This can optionally be done specifically for a forest to be equipped with a forest fire early detection system 1. The ML data set MLD is determined from these measurement data determined experimentally in the laboratory. An ML data set MLD is therefore created with data on true-positive events—i.e. events whose data represent a forest fire in its early phase. This enables the sensor to use its control unit to compare the recorded measurement data with the ML data set MLD and, if there is a match, to send a corresponding message to the network server NS via the communication interface of the terminal device ED. The first ML data set MLD is played on the terminal device ED before the forest fire early detection system is installed. The terminal device ED then determines the result data RDnn from the measurement data and the ML data MLD. This has the advantage that the terminal device ED only has to send a message to the network server NS in the event of a forest fire being detected. The frequency of the transmitted data is therefore significantly lower and the amounts of data sent are significantly smaller compared to sending the measurement data and determining the result data RDnn on the network server NS.

The result data RDnn is sent as a data packet wirelessly to one or more gateways G1, G2, Gn using a single-hop connection via LoRa (chirp frequency spread modulation) or frequency modulation. Since the communication interface of the terminal device ED, which usually has a high energy consumption, is not used for this, but rather the energy-saving control unit, the energy consumption of the terminal device ED is reduced. The standard LoRa wireless network has a star topology in which one or more terminal devices EDn are connected directly (single hub) via radio to gateways G1, G2, Gn using LoRa modulation or FSK modulation, while the gateways G1, G2, Gn communicate with the Internet network server NS using a standard Internet protocol IP. The Internet network server NS is connected to a second control unit MLS, which is suitable and intended to execute a machine learning program. In particular, the software of the terminal device is updated via the control unit at preferably regular intervals (see. FIGS. 5, 6).

FIG. 2 shows a sequence diagram of a known LoRaWAN network (see FIG. 1) according to the LoRaWAN protocol. In the star architecture of a LoRaWAN network, this communication occurs very quickly because each terminal device EDn communicates with the network server NS via at least one gateway G1. The terminal device ED1 records measurement data using the sensor unit arranged in the terminal device ED1 From this measurement data, the terminal device ED1 generates a set of result data RD1n using an ML data set stored in the memory of the terminal device ED1. The set of result data RD1n is sent e-s from a terminal device ED1 to a gateway G1. The gateway G1 forwards g-f this result data RD1n to the network server NS, which forwards the result data RD1n to the second control unit MLS. On the second control unit MLS, a machine learning algorithm is applied to the result data RD1n, thus generating an ML data set MLD. The second control unit MLS sends a-s the ML data set MLD to the network server NS, which sends the ML data set MLD back n-s to the gateway G1. The gateway G1 in turn forwards g-f the ML data set MLD to the terminal device ED1. The ML data set MLD is received e-r by the terminal device ED1 and stored in the memory of the terminal device ED1 in such a way that the ML data set MLD sent by the second control unit MLS replaces the ML data set previously stored in the memory of the terminal device ED1.

FIG. 3 shows an embodiment of the forest fire early detection system 1 according to the invention with a LoRaWAN mesh gateway network, in which the gateways Gn (see. FIG. 1) are mesh gateways MGDn. The mesh gateways MGDn communicate with each other using a multi-hub wireless network, and at least one mesh gateway MGDn-in this exemplary embodiment the mesh gateways MGD3, MGD5, MGD7—is connected to the network server NS via the standard Internet protocol IP. The mesh gateways MGDn forward the result data RDnn recorded by the terminal devices EDn to one another without any special hierarchy until a terminal device EDn can finally hand over the result data RDnn to a network server NS.

The LoRaWAN mesh gateway network of the forest fire early detection system 1 can optionally have one or more second servers that execute the functionalities of the network server NS. In particular, the second server, like the network server NS, is also connected to the second control unit MLS.

In a further variant of the LoRaWAN mesh gateway network, some or all mesh gateways MGDn have a sub-server unit with a processor and storage unit, which is equipped with a program and/or operating system and/or firmware that is suitable for carrying out the functionalities intended for the network server NS according to the LoRaWAN protocol. Such mesh gateways MGDn are thus at the same time second servers and are connected to the second control unit MLS. The forest fire early detection system 1 according to the invention, comprising a LoRaWAN mesh gateway network, is therefore designed to be redundant as desired and has a high level of reliability and, in particular, can be expanded as desired.

To detect a forest fire, measurement data is recorded by the sensor device of the terminal device EDn of the forest fire early detection system 1. The first control device of each terminal device EDn generates a result data set RDnn by applying ML data to the recorded measurement data. The result data RDnn is sent wirelessly as a data packet to one or more mesh gateway MGDn using a single-hop connection. The mesh gateway MGDn send the result data RDnn to each other using a multi-hop connection until the mesh gateways MGD3, MGD5, MGD7 send the result data RDnn to the network server NS using an IP connection. The network server NS finally sends the result data RDnn to the second control unit MLS, which is coupled to the network server NS. On the second control unit MLS, a machine learning algorithm is applied to the result data RDnn, thus generating an ML data set MLD. The generated ML data set MLD is sent via multi-hop connection and single-hop connection to each individual terminal device EDn arranged in the forest fire early detection system 1, meaning every terminal device EDn has the same ML data set in its memory.

FIG. 4 shows a sequence diagram of a LoRaWAN mesh gateway network 1, which no longer has the typical star architecture. Here, several mesh gateways MGD1, MGD2, MGDn are arranged between the terminal device ED and the network server NS, not all of which have a single-hop connection to the network server NS. The set of result data RD1n generated by a terminal device ED1 is forwarded g1-f, g2-f via several mesh gateways MGD1, MGD2, MGDn to the network server NS, which forwards the result data RD1n to the second control unit MLS. The ML data set MLD generated on the second control unit MLS is sent a-s by the second control unit MLS to the network server NS. The network server NS in turn sends n-s the ML data set MLD to one or more mesh gateways MGDn connected to the network server NS via Internet protocol IP, which forward g2-f, g1-f the ML data set MLD via a multi-hop connection via further mesh gateways MGD2, MGD1, which act as an intermediate station, to a terminal device ED1. The terminal device ED1 finally receives e-r the ML data set MLD and the ML data set previously stored in the memory of the terminal device ED1.

A further exemplary embodiment of a forest fire early detection system 1 is shown in FIG. 5, wherein the ML data set in the memory of a terminal device EDn is updated at intervals. The forest fire early detection system 10 has a plurality of terminal devices EDn, which are connected to gateways Gn via single-hop connections. The gateways Gn are connected to the network server NS, for example via a wired connection or via a wireless connection using the Internet protocol IP.

To detect a forest fire, measurement data is recorded by the sensor device of the terminal device EDn of the forest fire early detection system 1. The first control device of a terminal device EDn generates a first result data set RDn1. This first result data RDn1 is sent as a data packet wirelessly to one or more gateways G1, G2, Gn by each terminal device EDn using a single-hop connection via LoRa (chirp frequency spread modulation) or frequency modulation. A gateway Gn sends the first result data set RDn1 to the network server NS, which sends the first result data set RDn1 to the second control unit MLS. The second control unit MLS uses a machine learning algorithm and the first result data set RDn1 to generate a first ML data set MLDn1, which is sent to the terminal devices EDn via the gateways G1, G2, Gn. The first ML data set MLDn1 replaces the ML data set previously stored in the terminal device EDn.

At a later, second time, further measurement data is recorded by the sensor device of the terminal device EDn of the forest fire early detection system 1. The first control device of a terminal device EDn generates a second result data set RDn2. This second result data set RDn2 is sent wirelessly from each terminal device EDn as a data packet to one or more gateways G1, G2, Gn using a single-hop connection. A gateway Gn sends the second result data set RDn2 to the network server NS, which sends the second result data set RDn2 to the second control unit MLS. The second control unit MLS uses a machine learning algorithm and the second result data set RDn2 to generate a second ML data set MLDn2, which is sent to the terminal devices EDn via the gateways G1, G2, Gn. The second ML data set MLDn2 replaces the first ML data set MLDn1 previously stored in the terminal device EDn.

In an analogous manner, this described method for detecting a forest fire is carried out ad infinitum at further later times in such a way that both result data sets RDnn are sent to the network server NS and the second control device MLS, and ML data sets MLDnn are sent to the terminal devices EDn at definable intervals. The intervals can be time-based and/or data volume-based.

The ML algorithm of the second control device MLS preferably uses reinforcement learning, the ML algorithm learns a tactic through reward and punishment on how to act in potentially occurring situations in order to maximize the benefit of the forest fire monitoring system 1. The result data sets RDnn of the terminal devices EDn are training data sets for optimizing the ML algorithm.

FIG. 6 shows a sequence diagram of a forest fire early detection system 1 of the previous exemplary embodiment (see FIG. 5). From the measurement data, the terminal device ED1 generates a first set of result data RD1n using an ML data set stored in the memory of the terminal device ED1. The set of result data RD1n is sent e-s from a terminal device ED1 to a gateway G1. The gateway G1 forwards g-f this result data RD1n to the network server NS, which forwards the result data RD1n to the second control unit MLS. On the second control unit MLS, the machine learning algorithm is applied to the result data RD1n, thus generating a first ML data set MLD1. The second control unit MLS sends a-s the ML data set MLD1 to the network server NS, which sends the ML data set MLD1 back n-s to the gateway G1. The gateway G1 in turn forwards g-f the ML data set MLD1 to the terminal device ED1. The ML data set MLD1 is received e-r by the terminal device ED1 and stored in the memory of the terminal device ED1 in such a way that the ML data set MLD1 sent by the second control unit MLS replaces the ML data set previously stored in the memory of the terminal device ED1.

LIST OF REFERENCE SIGNS

| | |
|---|---|
| 1 | Forest fire early detection system |
| ED, EDn | Terminal devices |
| G, Gn | Gateways |
| NS | Internet network server |
| MLS | Machine learning server/ML server having |
| | ML algorithm/second control unit |
| MGD1, MGDn | Mesh gateways |
| e-s | Sending messages from the terminal device |
| e-r | Receiving messages from the terminal device |
| gf, g1-f, g2-f, gn-f | Forwarding messages from the gateway |
| n-r | Receiving messages on the network server |
| n-s | Sending messages from the network server |
| a-r | Receiving messages from the |
| | second control unit |
| a-s | Sending messages from the |
| | second control unit |
| RD1, RDn | Result data |
| RD1n, RDnn | Result data of the nth cycle |
| MLD, MLDn | ML data |
| MLD1n, MLDnn | ML data of the nth cycle |

1. A method for forest fire early detection having the method steps
implementation of ML data for the detection of forest fires in a forest fire early detection system (1),
acquisition of measurement data by a terminal device (ED) of the forest fire early detection system (1) and
determining result data (RDnn) by application of the ML data to the measurement data recorded by the terminal device (ED),
wherein the ML data is implemented in the terminal device (ED).

2. The method for forest fire early detection according to claim 1,
characterized in that
the result data (RDnn) is determined on the terminal device (ED).

3. The method for forest fire early detection according to claim 1,
characterized in that
the result data (RDnn) is transmitted to a network server (NS).

4. The method for forest fire early detection according to claim 3,
characterized in that
only part of the result data (RDnn) is transmitted to the network server (NS).

5. The method for forest fire early detection according to claim 3,
characterized in that
the transmission takes place using protocols such as LoRa, LoRaWAN and/or IP.

6. The method for forest fire early detection according to claim 3,
characterized in that
the result data (RDnn) is collected on the terminal device (ED).

7. The method for forest fire early detection according to claim 6,
characterized in that
the collected result data (RDnn) is transmitted to the network server (NS) at specified intervals.

8. The method for forest fire early detection according to claim 7,
characterized in that
the intervals are time-based or data volume-based.

9. The method for forest fire early detection according to claim 3,
characterized in that
the terminal device (ED) has a communication unit,
wherein the communication unit is deactivated after the transmission of the result data (RDnn).

10. The method for forest fire early detection according to claim 1,
characterized in that
an ML algorithm is applied to the result data (RDnn).

11. The method for forest fire early detection according to claim 1,
characterized in that
the first application of the ML algorithm takes place before the software is installed on the terminal device (ED) and/or before the sensor device is installed within a forest fire monitoring system (1).

12. The method for forest fire early detection according to claim 1,
characterized in that
an application of the ML algorithm takes place after the software is installed on the terminal device (ED) and/or before the sensor device is installed within a forest fire monitoring system (1).

13. The method for forest fire early detection according to claim 12,
characterized in that
the newly determined ML data (MLD) is transmitted to the terminal devices (ED) via a wireless network.

14. The method for forest fire early detection according to claim 1,
characterized in that
reinforcement learning is used.

15. A forest fire early detection system (1) with a LoRaWAN network comprising
a terminal device (ED), the terminal device (ED) having a sensor device, a first control device, an evaluation device for evaluating measurement signals supplied by the sensor device and a device for supplying energy,
a network server (NS),
characterized in that
the first control device is suitable and intended to access a memory that contains data from the adaptation and application of a machine learning model.

16. The forest fire early detection system (1) with a LoRaWAN network according to claim 15,
characterized in that
the memory is part of the terminal device (ED).

17. The forest fire early detection system (1) with a LoRaWAN network according to claim 15,
characterized in that
the network server (NS) is coupled to a second control device (MLS) which is suitable and intended to execute a machine learning program.

18. The forest fire early detection system (1) with a LoRaWAN network according to claim 15,
characterized in that
the second control device (MLS) has access to the measurement signals recorded by the terminal device (ED).

19. The forest fire early detection system (1) with a LoRaWAN network according to claim 15,
characterized in that
the second control device (MLS) is connected to the terminal device (ED) via two different networks.

20. The forest fire early detection system (1) with a LoRaWAN network according to claim 15,
characterized in that
the terminal device (ED) has a humidity sensor for detecting the air humidity.

21. The forest fire early detection system (1) with a LoRaWAN network according to claim 15,
characterized in that
the terminal device (ED) has a temperature sensor for detecting the ambient temperature.

22. The forest fire early detection system (1) with a LoRaWAN network according to claim 15,
characterized in that
the terminal device (ED) has a pressure sensor for detecting the air pressure.
